(19) United States
(12) Patent Application Publication
(10) Pub. No.: US 2014/0112633 A1
(43) Pub. Date: Apr. 24, 2014

(54) METHOD AND SYSTEM FOR NETWORK-BASED REAL-TIME VIDEO DISPLAY

(71) Applicant: OMNIVISION TECHNOLOGIES (SHANGHAI) CO., LTD., Shanghai (CN)

(72) Inventor: KAH-ONG TAN, Shanghai (CN)

(73) Assignee: OmniVision Technologies (Shanghai) Co., Ltd., Shanghai (CN)

(21) Appl. No.: 13/718,988

(22) Filed: Dec. 18, 2012

(30) Foreign Application Priority Data
Oct. 19, 2012 (CN) 201210402391.0

(51) Int. Cl. H04N 5/77

(52) U.S. Cl. CPC H04N 5/77
USPC 386/223; 386/224

(57) ABSTRACT

A method for network-based real-time video display is disclosed. The method includes: setting up a connection between an imaging apparatus and a website via a wireless network; producing a video by the imaging apparatus and displaying the video by the website if the imaging apparatus is successfully authenticated, wherein producing a video by the imaging apparatus includes: recording a video and splitting the video into video segments; processing and converting the video segments into a video stream; and uploading the video stream to the website, further wherein, displaying the video by the website includes: offering a display widget to the video stream and creating a display window for the video; embedding the display window in a corresponding display page; and displaying the video through the display window in real time. A system for network-based real-time video display is also disclosed.

### CROSS-REFERENCES TO RELATED APPLICATIONS

This application claims the priority of Chinese patent application number 201210402391.0 filed on Oct. 19, 2012, the entire contents of which are incorporated herein by reference.

### TECHNICAL FIELD

The present invention relates to a method and system for network-based real-time video display.

### BACKGROUND

As shown in FIG. 1, an imaging apparatus capable of combining an image of a figure and an image of a site viewed by the figure was disclosed in the applicant's Chinese patent application No. 201120249931.7 A video recorded by such an apparatus creates a sense of live on-site broadcast.

Currently, both video displaying websites and blogging websites on the Internet permit individual users to upload video content generated by themselves. As shown in FIG. 2, after video content has been checked and approved by a website, it can be accessed and viewed by other users. In this manner, individuals can share video content with their friends or the public, following the steps of: S11, recording a video with an imaging apparatus; S12, storing the video on a graphic memory, such as a secure digital (SD) flash card; S13, uploading the video to a website on the Internet; S14, checking the video by the website; and S15, displaying the video when a user clicks it after it is approved by the website to be displayed. In such a process, a relatively long span will be generated between the time when a video was produced and the time when it is available to be viewed. Therefore, it cannot meet some users' demand for displaying a video in real time and the video will hence not attract wide attention or receive a great number of hits.

### SUMMARY OF THE INVENTION

An objective of the present invention is to provide a method and system for network-based real-time video display, which is capable of meeting users' demand for displaying a video in real time and thereby helping the video attract wider attention and obtain more hits.

To achieve the above objective, a first aspect of the present invention provides a method for network-based real-time video display, which includes the steps of:

setting up a connection between an imaging apparatus and a website via a wireless network:

authenticating the imaging apparatus by the website;

informing the imaging apparatus of a rejection message by the website if the imaging apparatus is not successfully authenticated; or

producing a video by the imaging apparatus and displaying the video by the website if the imaging apparatus is successfully authenticated,

wherein producing a video by the imaging apparatus includes:
recording a video and splitting the video into video segments;
processing and converting the video segments into a video stream; and
uploading the video stream to the website via the wireless network,

further wherein, displaying the video by the website includes:
offering a display widget to the video stream and creating a display window the video;
embedding the display window in a corresponding display page; and
displaying the video through the display window in real time.

In an embodiment, the imaging apparatus includes two or more cameras; recording a video and splitting the video into video segments includes recording a video by each of the two or more cameras and splitting each video into video segments; and processing and converting the video segments into a video stream includes synthesizing the video segments of the videos recorded by the two or more cameras and converting the synthesized video segments into a video stream.

In an embodiment, the website is hosted on a cloud server.

In an embodiment, the method further includes: checking the uploaded video stream by the website before displaying the video; and informing the imaging apparatus of a refuse message and terminating the step of displaying the video, if the video stream is not approved to be displayed.

In an embodiment, the video stream is checked by the website in an algorithmic manner and/or a manual manner.

A second aspect of the present invention provides a method for network-based real-time video display, which includes the steps of:

setting up a connection between a plurality of imaging apparatuses and a website via a wireless network;

authenticating each of the plurality of imaging apparatuses by the website, wherein:

for each imaging apparatus being not successfully authenticated, the method further includes informing the imaging apparatus of a rejection message by the website;

for all the imaging apparatuses being successfully authenticated, the method further includes producing a video by each of one or more the imaging apparatuses and displaying the produced one or more videos by the website, further wherein:

producing a video includes:
recording a video and splitting the video into video segments;
processing and converting the video segments into a video stream; and
uploading the video stream to the website via the wireless network;

displaying the produced one or more videos by the website includes:
offering a display widget to each of the one or more video streams uploaded and creating a display window for each of the one or more videos;
embedding each display window in a corresponding display page; and
displaying the one or more videos through the display windows in real time.

In an embodiment, recording a video further includes acquiring a location information of the imaging apparatus; and processing and converting the video segments into a video stream further includes inserting the location information into control fields of the video stream.

In an embodiment, the website is hosted on a cloud server.

In an embodiment, a plurality of display windows, each displaying a corresponding video, may be embedded in a same display page.

In an embodiment, embedding each display window in a corresponding display page includes: embedding a smaller number of display windows with a greater size in an initially created display page, while embedding a greater number of display windows with a smaller size in each subsequently created display page.

In an embodiment, embedding each display window in a corresponding display page includes: arranging the plurality of display windows on the same display page in a reverse order of creation time of the plurality of display windows.

In an embodiment, embedding each display window in a corresponding display page includes: arranging the plurality of display windows on the same display page in an order from a highest attention degree to a lowest attention degree of the plurality of display windows.

In an embodiment, each of the one or more videos includes a creator information thereof; the method further includes finding a target display window by searching the creator information of the one or more videos.

In an embodiment, the method further includes finding a target display window by searching the location information of the one or more videos.

In an embodiment, the location information includes any one or a combination a name, latitude and longitude, and a position displayed on a map, of the location.

In an embodiment, the method further includes: checking each of the uploaded one or video streams by the website before displaying each of the one or more videos, wherein for each video stream being not approved to be displayed, the method further includes informing the corresponding imaging apparatus of a refuse message and terminating the step of displaying the corresponding video.

In an embodiment, each of the uploaded one or more video streams is checked by the website in an algorithmic manner and/or a manual manner.

A third aspect of the present invention provides a system for network-based real-time video display. The system includes one or more imaging apparatuses and a website, each of the one or more imaging apparatuses recording a video,

wherein each of the one or more imaging apparatuses includes:
at least one camera for recording the video;
a video processing module for splitting the video into video segments and converting the video segments into a video stream; and
a wireless transmission module for setting up a connection between the imaging apparatus and the website via a wireless network and uploading the video stream to the website in real time,

further wherein the website authenticates each of the one or more imaging apparatuses; for each imaging apparatus being not successfully authenticated, the website informs the imaging apparatus of a rejection message; for each imaging apparatus being successfully authenticated, the website offers a display widget to the video stream uploaded by the imaging apparatus, creates a display window for the video recorded by the imaging apparatus, embeds the display window in a corresponding display page, and displays the video through the display window in real time.

In an embodiment, each of the one or more imaging apparatuses includes two or more cameras for synchronously recording videos at different angles, the video processing module splitting each of the videos recorded by the two or more cameras into video segments, synthesizing the video segments of the videos recorded by the two or more cameras, and converting the synthesized video segments into a video stream.

In an embodiment, each of the one or more imaging apparatuses further includes a GPS module for acquiring a location information of the imaging apparatus, the video processing module inserting the location information into control fields of the video stream.

Compared with the prior art, the present invention is capable of meeting users' demand for displaying a video in real time and thereby helping the video attract wider attention and obtain more hits.

### BRIEF DESCRIPTION OF THE DRAWINGS

FIG. 1 is a schematic diagram illustrating an imaging method of the prior art which can produce a video that creates a sense of live broadcasting.

FIG. 2 is a flow chart illustrating a process of displaying a video in accordance with the prior art.

FIG. 3 is a flow chart illustrating the method for network-based real-time video display constructed in accordance with the first embodiment of the present invention.

FIG. 4 is a schematic diagram illustrating a first layout type of display pages in accordance with the first to third embodiments of the present invention.

FIG. 5 is a schematic diagram illustrating a second layout type of display pages in accordance with the first to third embodiments of the present invention.

FIG. 6 is a schematic diagram illustrating a third layout type of display pages in accordance with the first to third embodiments of the present invention.

FIG. 7 is a schematic diagram illustrating a fourth layout type of display pages in accordance with the first to third embodiments of the present invention.

FIG. 8 is a schematic diagram illustrating a result of location information-based search in accordance with the first to the third embodiments of the present invention.

FIG. 9 is a schematic diagram illustrating a result of creator information-based search in accordance with the first to the third embodiments of the present invention.

FIG. 10 is a flow chart illustrating the method for network-based real-time video display constructed in accordance with the second embodiment of the present invention.

FIG. 11 is a schematic illustration of the system for network-based real-time video display constructed in accordance with the third embodiment of the present invention.

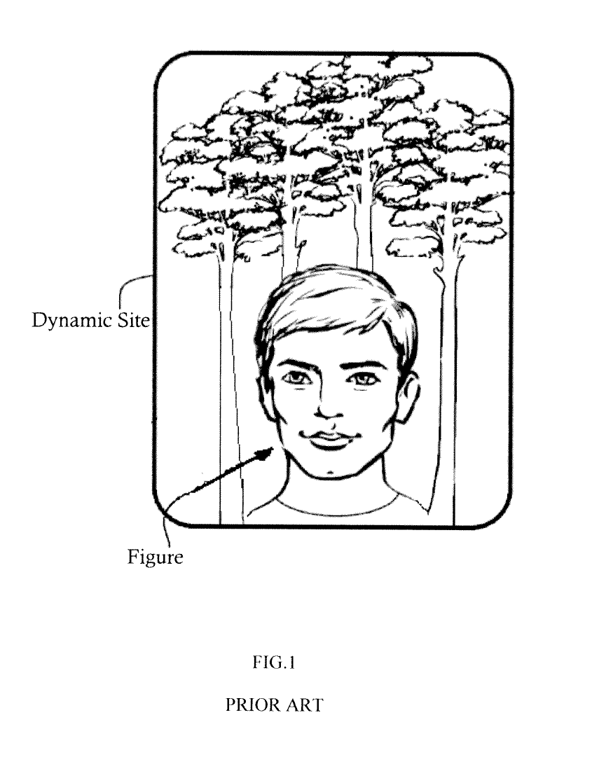

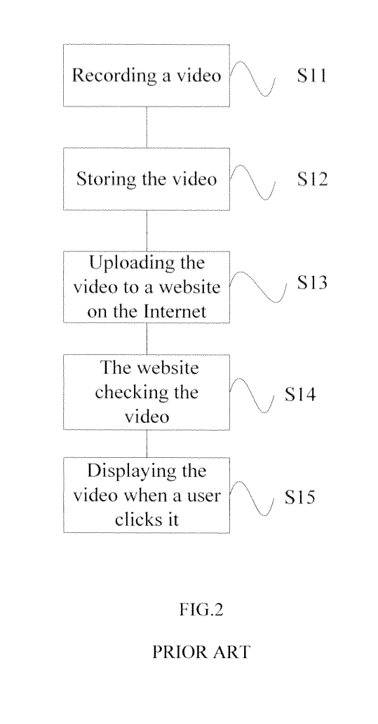

### DETAILED DESCRIPTION

Foregoing purposes, characteristics and advantages of the present invention will be clearer and easier to be understood upon reading the following description of specific embodiments with reference accompanying drawings.

### First Embodiment

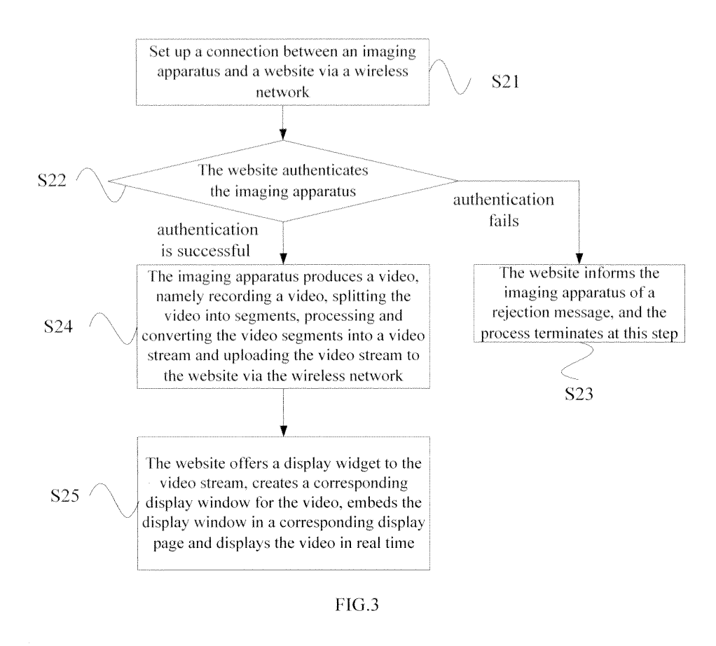

As shown in FIG. 3 the present invention provides a method network-based real-time video display, the method includes the steps of:

S21: set up a connection between an imaging apparatus and a website via a wireless network, wherein, specifically, the imaging apparatus may be configured to automatically set up a connection to the website via the wireless network once it is powered on;

S22: the website authenticates the imaging apparatus; if the authentication fails, the process advances to step 23; if the authentication is successful, the process advances to step 24;

S23: the website informs the imaging apparatus of a rejection message, and the process terminates at this step;

S24: the imaging apparatus produces a video, namely recording a video, splitting the video into segments, processing and converting the video segments into a video stream and uploading the video stream to the website via the wireless network; and

S25: the website offers a display widget to the video stream, creates a corresponding display window for the video, embeds the display window in a corresponding display page and displays the video in real time, wherein, specifically, after the imaging apparatus is authenticated, it starts to record a video and uploads the video to the website in segments, and the website automatically offers a display widget to the video and displays the video in real time.

The imaging apparatus may include two or more cameras, which may be placed at predetermined positions so as to simultaneously record the video from different angles. Then, each of the videos recorded is split into video segments and the video segments of various videos are synthesized and converted into a video stream.

The imaging apparatus may acquire its location information during the recording of the video and may insert the location information into control fields of the video stream.

In order to improve its capacities of video processing, the website may be hosted on a cloud server so as to allow multiple imaging apparatuses to upload videos to the website and display the videos uploaded by the multiple imaging apparatuses at the same time.

A plurality of display windows displaying different videos may be embedded in a same display page.

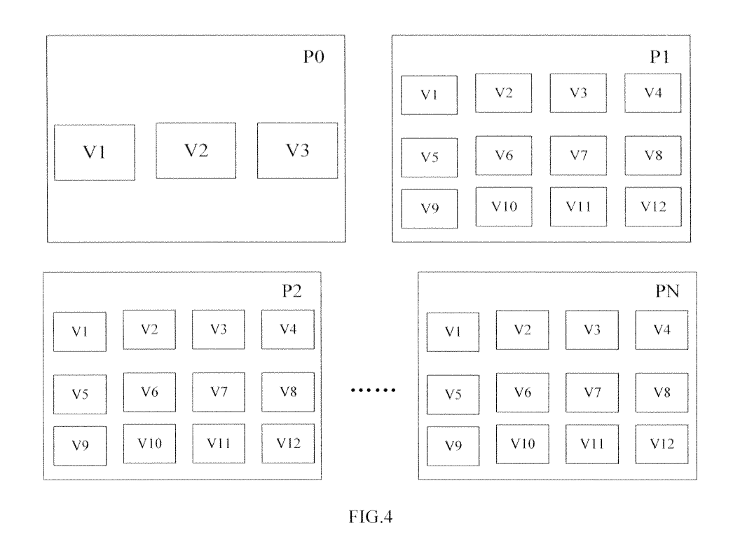

It is so configured that a smaller number display windows with a greater size may embedded in an initially created display page, while a greater number of display windows with a smaller size may be embedded in each of display pages created thereafter. Specifically, for example, as shown in FIG. 4, each of the display pages P0, P1, P2, . . . , and PN, may include a plurality of display windows. The initially created display page P0 may be recommended as a top page, and three video display windows V1, V2 and V3 may be embedded therein, each having a greater size. While the rest display pages P1, P2, . . . , and PN, which are created later than the top recommended page P0. may hold a greater number of for example, twelve, smaller video windows V1, V2, . . . , and V12. Ihe number of video windows in each page may be changed according to real situations.

When a new imaging apparatus is successfully connected to the website, a new display window for displaying the video being recorded by this new imaging apparatus may be automatically created and embedded at a position behind all currently active display windows in the last created display page. When any of the imaging apparatuses connected to the website stops uploading a video, the real-time display of the video may be terminated, and the corresponding display window may be removed from its initial position in the corresponding display page, and accordingly each of the display windows behind it (if exist) will be moved ahead by one position. Taking the case that there are three recommended display windows embedded in the initially created display page P0, twelve display windows, arrayed in 3 rows by 4 columns, in each later created page, and twenty-five imaging apparatuses being in connection with the website as an example, the website will display the twenty-five videos a1, a2, . . . , and a25 recorded by the twenty-five imaging apparatuses in real time in an order of the time that the connection was established from the earliest to the latest.

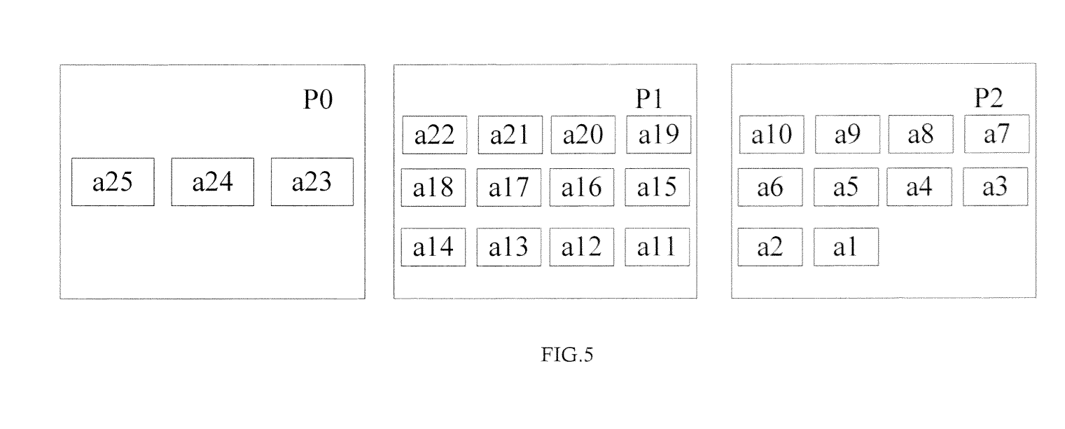

Alternatively, the display windows may be arranged on their corresponding display pages in an reverse order of the time that they are created. That is, as shown in FIG. 5, the twenty-five videos may be arranged into the order of a25, . . . , a2 and a1, according to the rule that the video recorded by the latest connected imaging apparatus is arranged at the topmost position.

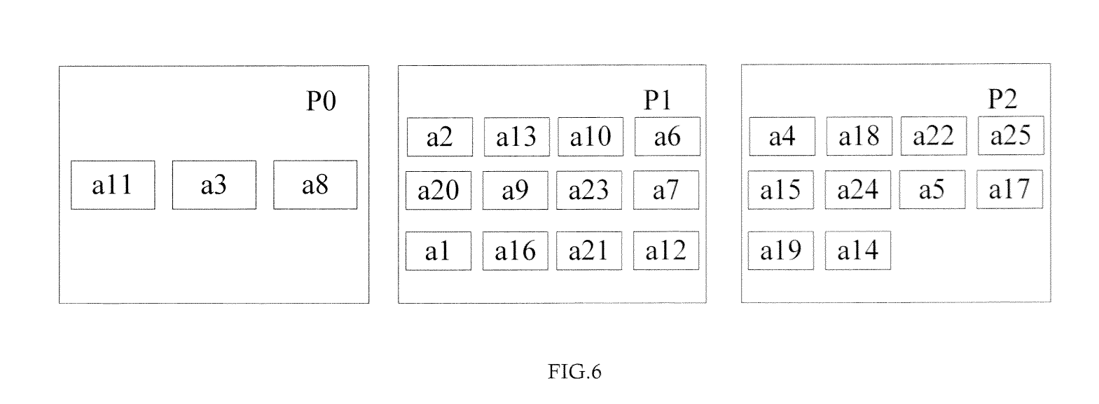

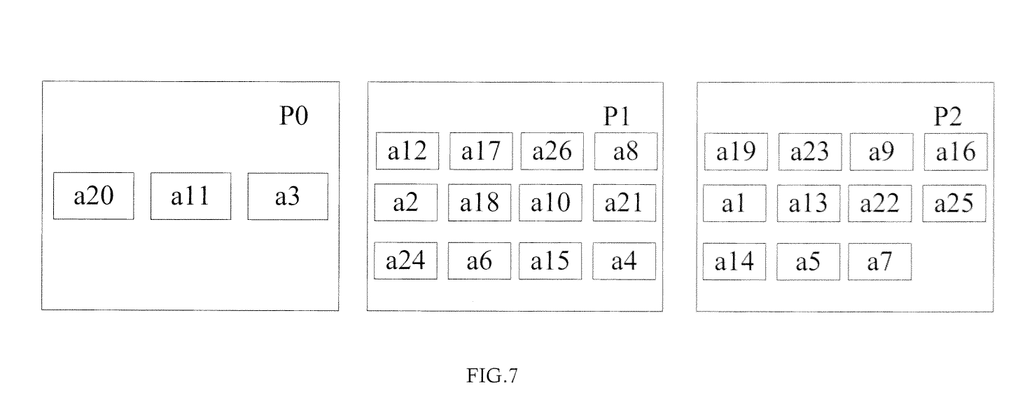

Alternatively, the display windows may be arranged on corresponding display pages according to their degrees of attention from high to low. That is, the videos may be arranged according to their number of hits or degree of attention from users according to the rule that the most popular video is arranged at the topmost position. For example, as shown in FIG. 6, the most popular three videos a11, a3 and a8 are displayed at the top recommended page P0. In addition, the arrangement order of the display windows on the website is regularly updated. That is to say after a predetermined interval, like one minute, all the display windows currently active will be rearranged according to their current degrees of attention. One example is given by FIGS. 6 and 7, wherein FIG. 6 shows the arrangement of display windows at a previous moment, while FIG. 7 shows the display windows rearranged after a predetermined interval from the previous moment. It can be seen from FIGS. 6 and 7 that a new imaging apparatus has been connected to the website during the predetermined interval, so that the number of display windows has been increased from twenty-five in FIG. 6 to twenty-six in FIG. 7. Besides, the arrangement order of the display windows has been changed according to the change of their degrees of attention.

Users visiting the website may find a target display window by searching the location information of the one or more videos.

The location information may include any one or a combination of a name, a latitude and longitude, and a position displayed on a map for users to click, of the location, such that, as shown in FIG. 8, users can obtain a collection of all active display windows of videos uploaded from a same location simply by inputting the name and/or the latitude and longitude and/or clicking a corresponding position displayed on a map of the location.

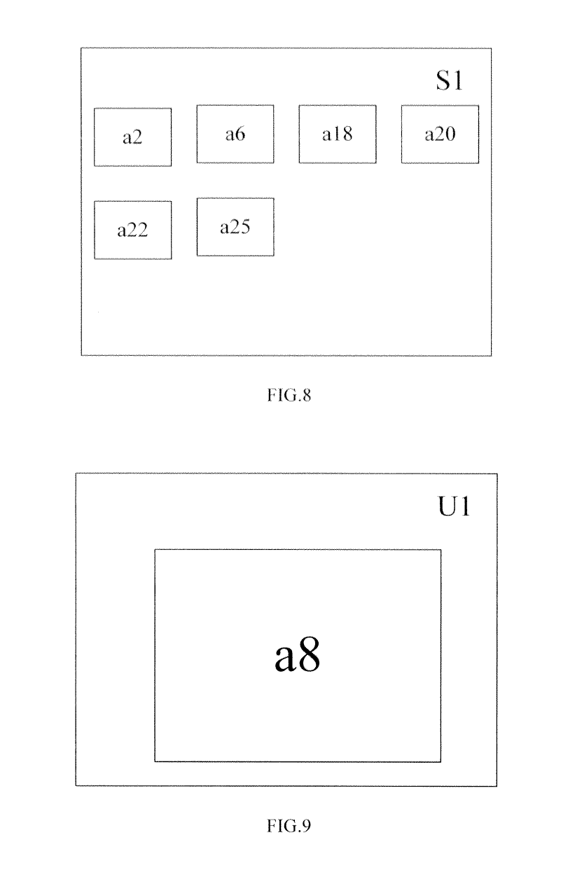

Alternatively, each video may include a creator information thereof, namely the information of the user who uploads the video. Users visiting the website can find a target display window by searching the creator information of the one or more videos, so as to obtain a search result such as the target display window a8 shown in FIG. 9. In this way, a user can easily find other users such as his/her relatives or friends and thereby pay close attention thereto. FIG. 9 may alternatively illustrate an enlarged display window obtained when the original display window located on a certain display page is clicked.

According to the foregoing description, in this embodiment, a method for network-based video display, arrangement and search in real time is disclosed. The method provides a platform for users to display real-time videos, including videos produced by synthesizing forward and backward scenes that can create a sense of live on-site broadcast. Moreover, the method can be utilized in a wide variety of applications and can eliminate the absence of live broadcasting service of current websites.

### Second Embodiment

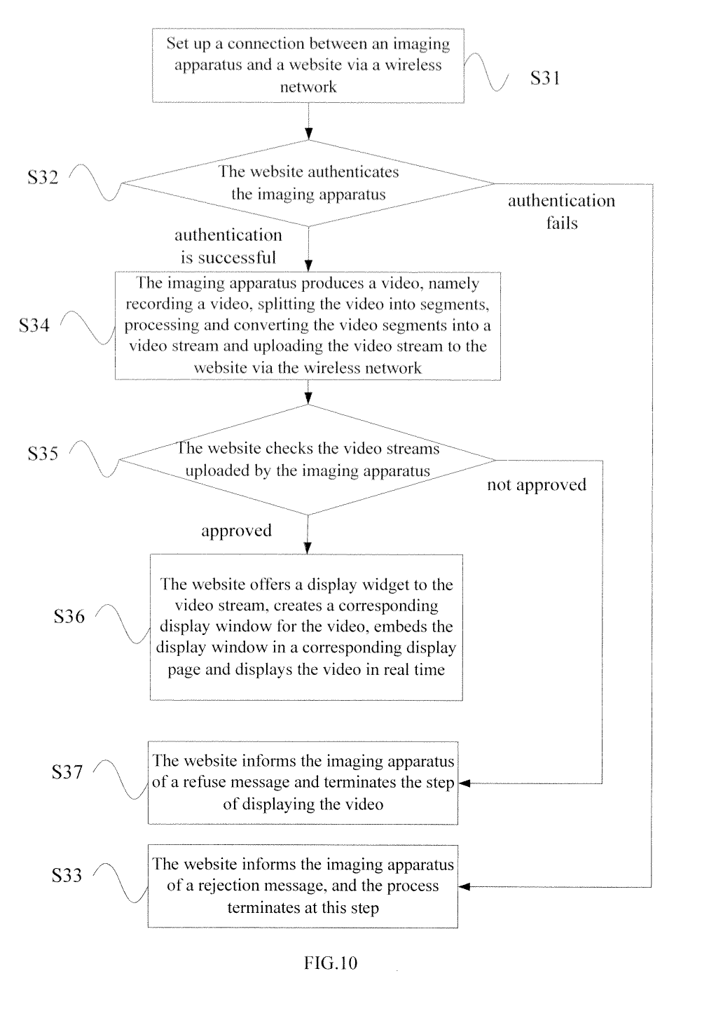

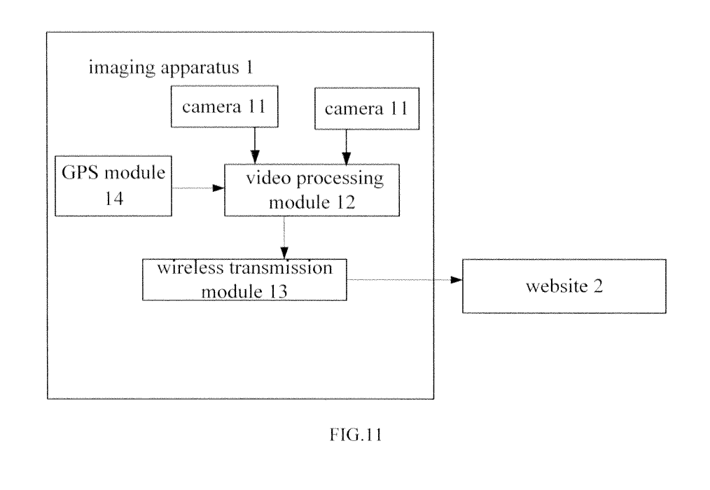

As shown in FIG. 10, the present invention further provides another method for network-based real-time video display. This embodiment differs from the first embodiment in further including a step of checking, by the website, each of the videos uploaded by the one or more imaging apparatuses. The method of this embodiment includes the steps of:

S31: set up a connection between an imaging apparatus and a website via a wireless network, wherein, specifically, the imaging apparatus may be configured to automatically set up a connection to the website via the wireless network once it is powered on;

S32: the website authenticates the imaging apparatus; if the authentication fails, the process advances to step 33; if the authentication is successful, the process advances to step 34;

S33: the website informs the imaging apparatus of rejection message, and the process terminates at this step;

S34: the imaging apparatus produces a video, namely recording a video, splitting the video into segments, processing and converting the video segments into a video stream and uploading the video stream to the website via the wireless network;

S35: the website checks the video stream uploaded by the imaging apparatus; if the video stream is approved to be displayed, the process advances to step 36; if the video stream is not approved to be displayed, the process advances to step 37;

S36: the website offers a display widget to the video stream, creates a corresponding display window for the video, embeds the display window in a corresponding display page and displays the video in real time, wherein, specifically, after the imaging apparatus is authenticated, it starts to record a video and uploads the video to the website in segments, and the website automatically offers a display widget to the video and displays the video in real time; and

S37: the website informs the imaging apparatus of a refuse message and the process terminates at this step without displaying the video.

The imaging apparatus may include two or more cameras, which may be placed at predetermined positions so as to simultaneously record the video from different angles. Then, each of the videos recorded is split into video segments and the video segments of various videos are synthesized and converted into a video stream.

The imaging apparatus may acquire its location information during the recording of the video and may insert the location information into control fields of the video stream.

In order to improve its capacities of video processing, the website may be hosted on a cloud server so as to allow multiple imaging apparatuses to upload videos to the website and display the videos uploaded by the multiple imaging apparatuses at the same time.

A plurality of display windows displaying different videos may be embedded in a same display page.

It is so configured that a smaller number of display windows with a greater size may be embedded in an initially created display page, while a greater number of display windows with a smaller size may be embedded in each of display pages created thereafter. Specifically, for example, as shown in FIG. 4, each of the display pages P0, P1, P2, . . . , and PN, may include a plurality of display windows. The initially created display page P0 may be recommended as a top page, and three video display windows V1, V2 and V3 may be embedded therein, each having a greater size. While the rest display pages P1, P2 . . . , and PN, which are created later than the top recommended page P0, may hold a greater number of, for example, twelve, smaller video windows V1, V2, . . . , and V12. The number of video windows in each page may be changed according to real situations.

When a new imaging apparatus is successfully connected to the website, a new display window for displaying the video being recorded by this new imaging apparatus may be automatically created and embedded at a position behind all currently active display windows in the last created display page. When any of the imaging apparatuses connected to the website stops uploading a video, the real-time display of the video may be terminated, and the corresponding display window may be removed from its initial position in the corresponding display page, and accordingly each of the display windows behind it (if exist) will be moved ahead by one position. Taking the case that there are three recommended display windows embedded in the initially created display page P0, twelve display windows, arrayed in 3 rows by 4 columns, in each later created page, and twenty-five imaging apparatuses being in connection with the website as an example, the website will display the twenty-five videos a1, a2, . . . , and a25 recorded by the twenty-five imaging apparatuses in real time in an order of the time that the connection was established from the earliest to the latest.

Alternatively, the display windows may be arranged on their corresponding display pages in an reverse order of the time that they are created. That is, as shown in FIG. 5, the twenty-five videos may be arranged into the order of a25, . . . , a2 and a1, according to the rule that the video recorded by the latest connected imaging apparatus is arranged at the topmost position.

Alternatively, the display windows may be arranged on corresponding display pages according to their degrees of attention from high to low. That is, the videos may be arranged according to their number of hits or degree of attention from users according to the rule that the most popular video is arranged at the topmost position. For example, as shown in FIG. 6, the most popular three videos a11, a3 and a8 are displayed at the top recommended page P0. In addition, the arrangement order of the display windows on the website is regularly updated. That is to say after a predetermined interval, like one minute, all the display windows currently active will be rearranged according to their current degrees of attention. One example is given by FIGS. 6 and 7, wherein FIG. 6 shows the arrangement of display windows at a previous moment, while FIG. 7 shows the display windows rearranged after a predetermined interval from the previous moment. It can be seen from FIGS. 6 and 7 that a new imaging apparatus has been connected to the website during the predetermined interval, so that the number of display windows has been increased from twenty-five in FIG. 6 to twenty-six in FIG. 7. Besides, the arrangement order of the display windows has been changed according to the change of their degrees of attention.

Users visiting the website may find a target display window by searching the location information of the one or more videos.

The location information may include any one or a combination of a name, a latitude and longitude, and a position displayed on a map for users to click, of the location, such that, as shown in FIG. 8, users can obtain a collection of all active display windows of videos uploaded from a same location simply by inputting the name and/or the latitude and longitude and/or clicking a corresponding position displayed on a map, of the location.

Alternatively, each video may include a creator information thereof, namely the information of the user who uploads the video. Users visiting the website can find a target display window by searching the creator information of the one or more videos, so as to obtain a search result such as the target display window a8 shown in FIG. 9. In this way, a user can easily find other users such as his/her relatives or friends and thereby pay close attention thereto. FIG. 9 may alternatively illustrate an enlarged display window obtained when the original display window located on a certain display page is clicked.

Each of the uploaded one or more video streams may be checked by the website in an algorithmic manner and/or a manual manner.

According to the foregoing description, in this embodiment, a method for network-based video display, arrangement and search in real time is disclosed. The method provides a platform for users to display real-time videos, including videos produced by synthesizing forward and backward scenes that can create a sense of live on-site broadcast. Moreover, the method can be utilized in a wide variety of applications and can eliminate the absence of live broadcasting service of current websites. Moreover, as the method of this embodiment further includes a step of checking the uploaded video stream in an algorithmic and/or a manual manner by the website, if any video is found to have content that violates laws or regulations, or is forbidden to be broadcasted, the real-time display of it can be interrupted whenever necessary.

### Third Embodiment

As shown in FIG. 11, the present invention also provides a system for network-based real-time video display, which includes one or more imaging apparatuses 1 and a website 2. For simplification, only one imaging apparatus is shown in FIG. 11, and the following description will only give an example of the operating processes between one imaging apparatus and the website. It shall be appreciated by those skilled in the art that these operating processes may be applied to any one of the imaging apparatuses being connected to the website.

Refer to FIG. 11, the imaging apparatus 1 sets up a connection to the website 2 via a wireless network, records a video and uploads the video to the website 2 in segments via the wireless network. Specifically, the imaging apparatus 1 may be configured to automatically set up a connection to the website 2 via the wireless network once it is powered on.

The imaging apparatus 1 includes:

at least one camera 11 for recording a video;

a video processing module 12 for splitting the video into segments, processing and converting the video segments into a video stream; and

a wireless transmission module 13 for setting up a connection between the imaging apparatus 1 and the website 2 via a wireless network and uploading the video stream to the website 2 via the wireless network.

The imaging apparatus 1 may include two or more cameras 11, which may be placed at predetermined positions so as to simultaneously record the video from different angles. The video processing module 12 splits each of the videos recorded into video segments, synthesizes the video segments of various videos, and converts the synthesized video segments into a video stream.

The imaging apparatus 1 may further include a Global Positioning System (GPS) module 14 for acquiring location information of the imaging apparatus 1 during the recording of the video, and the video processing module 12 may insert the location information into control fields of the video stream.

The website 2 authenticates the imaging apparatus 1 and informs the imaging apparatus of a rejection message if the authentication fails; otherwise, if the authentication is successful, the website 2 offers a display widget to the video stream, creates a corresponding display window for the video, embeds the display window in a corresponding display page and displays the video in real time, wherein, specifically, after the imaging apparatus 1 is authenticated, it starts to record a video and uploads the video to the website 2 in segments, and the website 2 automatically offers a display widget to the video and displays the video in real time.

In order to improve its capacities of video processing, the website 2 may be hosted on a cloud server so as to allow multiple imaging apparatuses 1 to upload videos to the website 2 and display the videos uploaded by the multiple imaging apparatuses 1 at the same time.

A plurality of display windows displaying different videos may be embedded in a display page.

It is so configured that a smaller number of display windows with a greater size may be embedded in an initially created display page, while a greater number of display windows with a smaller size may be embedded in each of display pages created thereafter. Specifically, for example, as shown in FIG. 4, each of the display pages P0, P1, P2, . . . , and PN, may include a plurality of display windows. The initially created display page P0 may be recommended as a top page, and three video display windows V1, V2 and V3 may be embedded therein, each having a greater size. While the rest display pages P1, P2, . . . , and PN, which are created later than the top recommended page P0, may hold a greater number of, for example, twelve, smaller video windows V1, and V2, . . . , and V12. The number of video windows in each page may be changed according to real situations.

When a new imaging apparatus is successfully connected to the website, a new display window for displaying the video being recorded by this new imaging apparatus may be automatically created and embedded at a position behind all currently active display windows in the last created display page. When any of the imaging apparatuses connected to the website stops uploading a video, the real-time display of the video may be terminated, and the corresponding display window may be removed from its initial position in the corresponding display page, and accordingly each of the display windows behind it (if exist) will be moved ahead by one position. Taking the case that there are three recommended display windows embedded in the initially created display page P0, twelve display windows, arrayed in 3 rows by 4 columns, in each later created page, and twenty-five imaging apparatuses being in connection with the website as an example, the website will display the twenty-five videos a1, a2, . . . , and a25 recorded by the twenty-five imaging apparatuses in real time in an order of the time that the connection was established from the earliest to the latest.

Alternatively, the display windows may be arranged on their corresponding display pages in an reverse order of the time that they are created. That is, as shown in FIG. 5, the twenty-five videos may be arranged into the order of a25, . . . , a2 and a1, according to the rule that the video recorded by the latest connected imaging apparatus is arranged at the topmost position.

Alternatively, display windows may be arranged on corresponding display pages according to their degrees of attention from high to low. That is, the videos may be arranged according to their number of hits or degree attention from users according the rule that the most popular video is arranged at the topmost position. For example, as shown in FIG. 6, the most popular three videos a11, a3 and a8 are displayed at the top recommended page P0. In addition, the arrangement order of the display windows on the website is regularly updated. That is to say after a predetermined interval, like one minute, all the display windows currently active will be rearranged according to their current degrees of attention. One example is given by FIGS. 6 and 7, wherein FIG. 6 shows the arrangement of display windows at a previous moment, while FIG. 7 shows the display windows rearranged after a predetermined interval from the previous moment. It can be seen from FIGS. 6 and 7 that a new imaging apparatus has been connected to the website during the predetermined interval, so that the number of display windows has been increased from twenty-five in FIG. 6 to twenty-six in FIG. 7. Besides, the arrangement order of the display windows has been changed according to the change of their degrees of attention.

Users visiting the website may find a target display window by searching the location information of the one or more videos.

The location information may include any one or a combination of a name, a latitude and longitude, and a position displayed on a map for users to click, of the location, such that, as shown in FIG. 8, users can obtain a collection of all active display windows of videos uploaded from a same location simply by inputting the name and/or the latitude and longitude and/or clicking a corresponding position displayed on a map, of the location, so as to obtain a search result such as the display window a2, a6, a18, a20, a22, a25 on the display page S1 shown in FIG. 8.

Alternatively, each video may include a creator information thereof, namely the information of the user who uploads the video. Users visiting the website can find a target display window by searching the creator information of the one or more videos, so as to obtain a search result such as the target display window a8 shown in FIG. 9. In this way, a user can easily find other users such as his/her relatives or friends and thereby pay close attention thereto. FIG. 9 may alternatively illustrate an enlarged display window obtained when the original display window located on a certain display page is clicked.

The website 2 may check the videos uploaded by the imaging apparatus 1, so that if any video is found to have content that violates laws or regulations, or is forbidden to be broadcasted, the website 2 may inform the imaging apparatus 1 of a refuse message and terminate the step of displaying the video.

The website 1 may check each uploaded video streams in an algorithmic and/or manual manner.

In conclusion, the present invention capable of meeting users' demand for displaying a video in real time and thereby helping the video attract wider attention and obtain more hits, by including the steps of: setting up a connection between an imaging apparatus and a website via a wireless network; authenticating the imaging apparatus by the website; informing the imaging apparatus of a rejection message by the website if the imaging apparatus is not successfully authenticated; or producing a video by the imaging apparatus and displaying the video by the website if the imaging apparatus is successfully authenticated, wherein producing a video by the imaging apparatus including: recording a video and splitting the video into video segments; processing and converting the video segments into a video stream; and uploading the video stream to the website via the wireless network, further wherein, displaying the video by the website including: offering a display widget to the video stream and creating a display window for the video; embedding the display window in a corresponding display page; and displaying the video through the display window in real time.

As the embodiments in this specification are described in a progressive manner, with each embodiment is described focusing on its difference from other embodiments, one can take reference to another embodiment for the description of a same or similar part if somewhere in a certain embodiment is found not described adequately. As the system disclosed by the third embodiment corresponds to the method disclosed by the first and second embodiments, description for the system is relatively simple. Thus, as indicated above, one can take reference to relevant description of the method to get a better understanding on the system.

Those skilled in the art can appreciate that the respective illustrative steps of the method and units of the device described here in connection with the disclosed embodiments can be implemented in electric hardware, in software or in combination thereof. The foregoing illustrative steps and units have been described in general in combination their functions in order to illustrate clearly exchangeability between hardware and software. Whether these functions are implemented in hardware or software is dependent upon a specific application and a design constrain of implementing the system. Those skilled in the art can implement the described functions in various ways for respective specific applications, but such an implementation result shall not be construed as departing from the scope of the invention.

Obviously, those skilled in the art can make various modifications and variations to the present invention without departing from the spirit or scope of the invention. Thus, it is intended that the present invention covers such modifications and variations provided they come within the scope of the appended claims and their equivalents.

What is claimed is:

1. A method for network-based real-time video display, the method comprising the steps of:
setting up a connection between an imaging apparatus and a website via a wireless network;
authenticating the imaging apparatus by the website;
informing the imaging apparatus of a rejection message by the website if the imaging apparatus is not successfully authenticated; or
producing a video by the imaging apparatus and displaying the video by the website if the imaging apparatus is successfully authenticated,
wherein producing a video by the imaging apparatus comprises:
recording a video and splitting the video into video segments;
processing and converting the video segments into a video stream; and
uploading the video stream to the website via the wireless network,
further wherein displaying the video by the website comprises:
offering a display widget to the video stream and creating a display window for the video;
embedding the display window in a corresponding display page; and
displaying the video through the display window in real time.

2. The method for network-based real-time video display according to claim 1, wherein:
the imaging apparatus comprises two or more cameras;
recording a video and splitting the video into video segments comprises recording a video by each of the two or more cameras and splitting each video into video segments; and
processing and converting the video segments into a video stream comprises synthesizing the video segments of the videos recorded by the two or more cameras and converting the synthesized video segments into a video stream.

3. The method for network-based real-time video display according to claim 1, wherein the website is hosted on a cloud server.

4. The method for network-based real-time video display according to claim 1, further comprising:
checking the uploaded video stream by the website before displaying the video; and
informing the imaging apparatus of a refuse message and terminating the step of displaying the video, if the video stream is not approved to be displayed.

5. The method for network-based real-time video display according to claim 4, wherein the video stream checked by the website in an algorithmic manner and/or a manual manner.

6. A method for network-based real-time video display, the method comprising the steps of:
setting up a connection between a plurality of imaging apparatuses and a website via a wireless network;
authenticating each of the plurality of imaging apparatuses by the website, wherein:
for each imaging apparatus being not successfully authenticated, the method further comprises informing the imaging apparatus of a rejection message by the website;
for all the imaging apparatuses being successfully authenticated, the method further comprises producing a video by each of one or more of the imaging apparatuses and displaying the produced one or more videos by the website, further wherein:
producing a video comprises:
recording a video and splitting the video into video segments;
processing and converting the video segments into a video stream; and
uploading the video stream to the website via the wireless network;
displaying the produced one or more videos by the website comprises:
offering a display widget to each of the one or more video streams uploaded and creating a display window for each of the one or more videos;
embedding each display window in a corresponding display page; and
displaying the one or more videos through the display windows in real time.

7. The method for network-based real-time video display according to claim 6, wherein:
recording a video further comprises acquiring a location information of the imaging apparatus; and
processing and converting the video segments into a video stream further comprises inserting the location information into control fields of the video stream.

8. The method for network-based real-time video display according to claim 6, wherein the website is hosted on a cloud server.

9. The method for network-based real-time video display according to claim 6, wherein a plurality of display windows, each displaying a corresponding video, may be embedded in a same display page.

10. The method for network-based real-time video display according to claim 9, wherein embedding each display window in a corresponding display page comprises:
embedding a smaller number of display windows with a greater size in an initially created display page, while embedding a greater number of display windows with a smaller site in each subsequently created display page.

11. The method for network-based real-time video display according to claim 9, wherein embedding each display window in a corresponding display page comprises:
arranging the plurality of display windows on the same display page in a reverse order of creation time of the plurality of display windows.

12. The method for network-based real-time video display according to claim 9, wherein embedding each display window in a corresponding display page comprises:
arranging the plurality of display windows on the same display page in an order from a highest attention degree to a lowest attention degree of the plurality of display windows.

13. The method for network-based real-time video display according to claim 9, wherein:
each of the one or more videos includes a creator information thereof;
the method further comprises finding a target display window by searching the creator information of the one or more videos.

14. The method for network-based real-time video display according to claim 7, wherein a plurality of display windows, each displaying a corresponding video, may be embedded in a same display page.

15. The method for network-based real-time video display according to claim 14, wherein the method further comprises finding a target display window by searching the location information of the one or more videos.

16. The method for network-based real-time video display according to claim 15, wherein the location information includes any one or a combination of a name, a latitude and longitude, and a position displayed on a map, of the location.

17. The method for network-based real-time video display according to claim 6, further comprising checking each of the uploaded one or more video streams by the website before displaying each of the one or more videos,
wherein for each video stream being not approved to be displayed, the method further comprises informing the corresponding imaging apparatus of a refuse message and terminating the step of displaying the corresponding video.

18. The method for network-based real-time video display according to claim 17, wherein each of the uploaded one or more video streams is checked by the website in an algorithmic manner and/or a manual manner.

19. A system for network-based real-time video display, the system comprising one or more imaging apparatuses and a website, each of the one or more imaging apparatuses recording a video,
wherein each of the one or more imaging apparatuses includes:
at least one camera for recording the video;
a video processing module for splitting the video into video segments and converting the video segments into a video stream; and
a wireless transmission module for setting up a connection between the imaging apparatus and the website via a wireless network and uploading the video stream to the website in real time,
further wherein the website authenticates each of the one or more imaging apparatuses; for each imaging apparatus being not successfully authenticated, the website informs the imaging apparatus of a rejection message; for each imaging apparatus being successfully authenticated, the website offers a display widget to the video stream uploaded by the imaging apparatus, creates a display window for the video recorded by the imaging apparatus, embeds the display window in a corresponding display page, and displays the video through the display window in real time.

20. The system for network-based real-time video display according to claim 19, wherein each of the one or more imaging apparatuses comprises two or more cameras for synchronously recording videos at different angles, the video processing module splitting each of the videos recorded by the two or more cameras into video segments, synthesizing the video segments of the videos recorded by the two or more cameras, and converting the synthesized video segments into a video stream.

21. The system for network-based real-time video display according to claim 19, wherein each of the one or more imaging apparatuses further includes a GPS module for acquiring a location information of the imaging apparatus, the video processing module inserting the location information into control fields of the video stream.
